(19) United States
(12) Patent Application Publication
(10) Pub. No.: US 2026/0190014 A1
(43) Pub. Date: Jul. 2, 2026

(54) AUTOMATICALLY ANCHORING AERIAL DRONES TO CELLULAR BASE STATIONS

(71) Applicants: AT&T Intellectual Property I, L.P., Atlanta, GA (US); AT&T Mobility II LLC, Atlanta, GA (US)

(72) Inventors: Jason Young, Buford, GA (US); Mitchell Traylor, Dallas, TX (US)

(21) Appl. No.: 19/007,113

(22) Filed: Dec. 31, 2024

(51) Int. Cl. H04W 48/16; H01Q 3/02; H01Q 13/02; H04W 48/20

(52) U.S. Cl. CPC H04W 48/16; H01Q 3/02; H01Q 13/02; H04W 48/20

(57) ABSTRACT

A method for automatically anchoring aerial drones to cellular base stations includes controlling a transceiver of an aerial drone to scan for radio frequency signals emitted from a plurality of cells of a radio access network, obtaining a set of data, wherein the set of data includes, for each cell of the plurality of cells: an identifier of the each cell, an amplitude of the radio frequency signals emitted by the each cell as measured by the transceiver, and a physical location of the each cell, selecting a first cell of the plurality of cells based on the amplitude of the radio frequency signals emitted by the first cell, controlling a directional antenna of the aerial drone to aim at the physical location of the first cell, and controlling the transceiver to establish a connection with a base station serving the first cell.

The present disclosure relates generally to wireless communications networks, and relates more particularly to devices, non-transitory computer-readable media, and methods for automatically anchoring aerial drones to cellular base stations.

### BACKGROUND

Next-generation 911 (NG911) and similar services utilize both manned vehicles and unmanned vehicles, including aerial drones, to expand surveillance areas and improve data collection for the purposes of responding to emergencies. For instance, aerial drones may be deployed to areas where large crowds are expected to gather for a short period of time (e.g., for a sports event, a festival, a political inauguration, or the like). The aerial drones may gather information that can help first responders in detecting and responding to emergencies safely and efficiently.

### SUMMARY

In one example, the present disclosure describes a device, computer-readable medium, and method for automatically anchoring aerial drones to cellular base stations. For instance, in one example, a method performed by a processing system including at least one processor includes controlling a transceiver of an aerial drone to scan for radio frequency signals emitted from a plurality of cells of a radio access network, obtaining a set of data, wherein the set of data includes, for each cell of the plurality of cells: an identifier of the each cell, an amplitude of the radio frequency signals emitted by the each cell as measured by the transceiver, and a physical location of the each cell, selecting a first cell of the plurality of cells based on the amplitude of the radio frequency signals emitted by the first cell, controlling a directional antenna of the aerial drone to aim at the physical location of the first cell, and controlling a modem of the aerial drone to establish a connection with a base station serving the first cell.

In another example, a non-transitory computer-readable medium stores instructions which, when executed by the processing system, cause the processing system to perform operations. The operations include controlling a transceiver of an aerial drone to scan for radio frequency signals emitted from a plurality of cells of a radio access network, obtaining a set of data, wherein the set of data includes, for each cell of the plurality of cells: an identifier of the each cell, an amplitude of the radio frequency signals emitted by the each cell as measured by the transceiver, and a physical location of the each cell, selecting a first cell of the plurality of cells based on the amplitude of the radio frequency signals emitted by the first cell, controlling a directional antenna of the aerial drone to aim at the physical location of the first cell, and controlling a modem of the aerial drone to establish a connection with a base station serving the first cell.

In another example, a system includes a processing system including at least one processor and a non-transitory computer-readable medium storing instructions which, when executed by the processing system, cause the processing system to perform operations. The operations include controlling a transceiver of an aerial drone to scan for radio frequency signals emitted from a plurality of cells of a radio access network, obtaining a set of data, wherein the set of data includes, for each cell of the plurality of cells: an identifier of the each cell, an amplitude of the radio frequency signals emitted by the each cell as measured by the transceiver, and a physical location of the each cell, selecting a first cell of the plurality of cells based on the amplitude of the radio frequency signals emitted by the first cell, controlling a directional antenna of the aerial drone to aim at the physical location of the first cell, and controlling a modem of the aerial drone to establish a connection with a base station serving the first cell.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for automatically anchoring aerial drones to cellular base stations may operate;

FIG. 2 illustrates a flowchart of an example method for automatically anchoring aerial drones to cellular base stations, according to the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides a system, method, and non-transitory computer readable medium for automatically anchoring aerial drones to cellular base stations. As discussed above, next-generation 911 (NG911) and similar services utilize both manned vehicles and unmanned vehicles, including aerial drones, to expand surveillance areas and improve data collection for the purposes of responding to emergencies. For instance, aerial drones may be deployed to areas where large crowds are expected to gather for a short period of time (e.g., for a sports event, a festival, a political inauguration, or the like). The aerial drones may gather information, such as video data, that can help first responders in detecting and responding to emergencies safely and efficiently.

The state of the art uses wireless fidelity (WiFi) hotspots or routers to provide WiFi links to aerial drones. In this case, the WiFi links are used for uplink video payloads only, while operation of the aerial drones is controlled using radio frequency (RF) controllers. The reliance on WiFi for uplink video payloads limits the ranges of the aerial drones and also imposes a throttle point on the bandwidth that the links can provide.

Drones that include long term evolution (LTE) or Fifth Generation (5G) modems may be able to communicate natively with a communications network, without relying on WiFi. These drones may employ omnidirectional antennas and choose serving cells (i.e., physical locations served by base stations, such as eNodeBs or gNodeBs) in a manner similar to other user endpoint devices (including smart phones, tablet computers, autonomous vehicles, and the like). For instance, the drones may attach to a serving cell for which the measured RF signal strength is strongest. However, these drones also tend to use significantly more resources than other user endpoint devices due to the continuous uplink video transmissions. For instance, each uplink video stream may require a minimum of five megabits per second (Mbps) of concurrent throughput. This consumes a great deal of network resources in the serving cell, which may negatively affect the experience of other users being served by the serving cell.

Some communications network service providers may mitigate the resource consumption by drones by imposing limits on the resolution, frames per second, sampling quality, or other quality metrics of the uplink video transmissions. Additionally, the service providers may limit the number of drones that are permitted to operate in each cell (e.g., one drone per cell) to preserve the quality of experience of other network users.

Examples of the present disclosure configure aerial drones with logic and hardware to strategically select the cells of a communications network to serve the drones. In particular, the logic and hardware will help an aerial drone to increase the quality (e.g., signal strength) of its WiFi links and to spread the drain on network resources due to drone operations among multiple cells. In one example, the present disclosure utilizes an aerial drone having a highly directional antenna mounted on a rotating assembly. The rotation of the antenna may be controlled by a direct current (DC) stepper motor with precise angular position feedback. A processing system and RF scanning circuitry of the aerial drone may cooperate to survey the physical layer cell identifiers (PCIs) of the surrounding network cells and the RF signal amplitude in each direction. The aerial drone may then “anchor” itself to a specific base station (e.g., cell tower, eNodeB, or gNodeB) of the communication network by continuously pointing the antenna at the specific base station, regardless of the physical location of the aerial drone.

In one example, a control graphical user interface (GUI) may display, for an operator of the aerial drone, which PCIs are seen when the aerial drone is traveling from various directions, so that users may manually choose to anchor multiple aerial drones to different PCIs in different directions to avoid placing too much of a demand on the resources of a single cell or small group of cells.

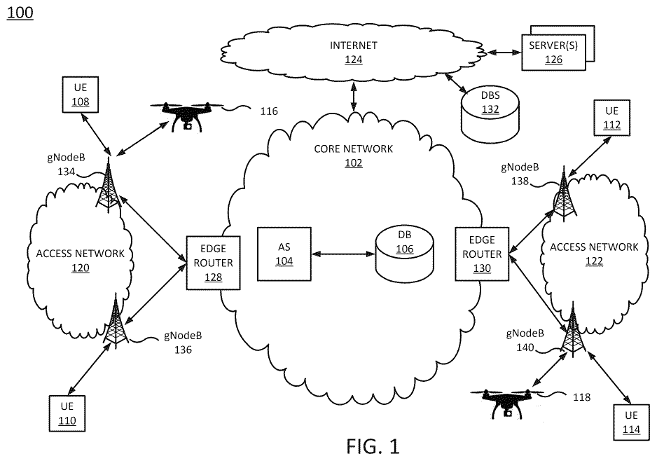

Although examples of the present disclosure are discussed within the context of first responder systems, it will be appreciated that examples of the present disclosure may improve the use of aerial drones in other applications as well, including industrial and military applications. By improving the quality of the RF link between the drone and the communications network, examples of the present disclosure may open many new avenues of product development. Examples of the present disclosure may also allow a greater number of drones to be operated in a communication network while minimizing the impact of drone operations on other users of the communication network. These and other aspects of the present disclosure are discussed in further detail with reference to FIGS. 1-3, below.

To further aid in understanding the present disclosure, FIG. 1 illustrates an example system 100 in which examples of the present disclosure for automatically anchoring aerial drones to cellular base stations may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

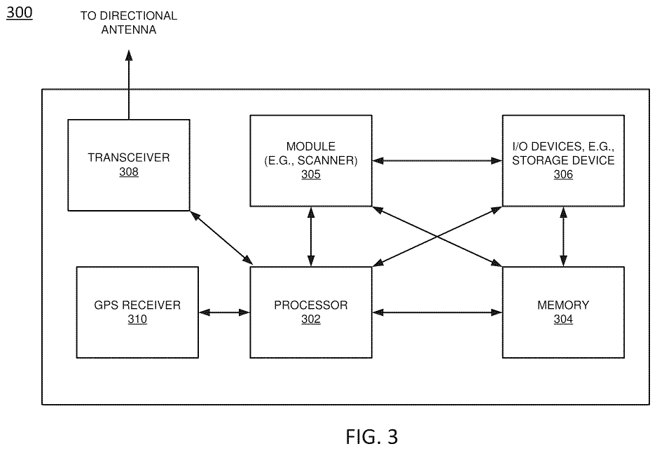

In one example, the access network 120 may be in communication with one or more user endpoint devices 108, 110, and 116. Similarly, the access network 122 may be in communication with one or more user endpoint devices 112, 114, and 118. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 300 depicted in FIG. 3, and may be configured as described below. For example, the user endpoint devices 108, 110, 112, and 114 may each comprise a smart phone, a tablet computer, a laptop computer, a gaming device, a wearable smart device (e.g., a smart watch, a head mounted display, or the like), an IoT device, a bank or cluster of such devices, and the like.

In one example, at least some of the user endpoint devices, e.g., devices 116 and 118 in FIG. 1, may comprise aerial drones. In one example, the aerial drones 116 and 118 may be operable to run an application that automatically selects a base station (e.g., base station 134, 136, 138, or 140) to which to anchor, as discussed in greater detail below.

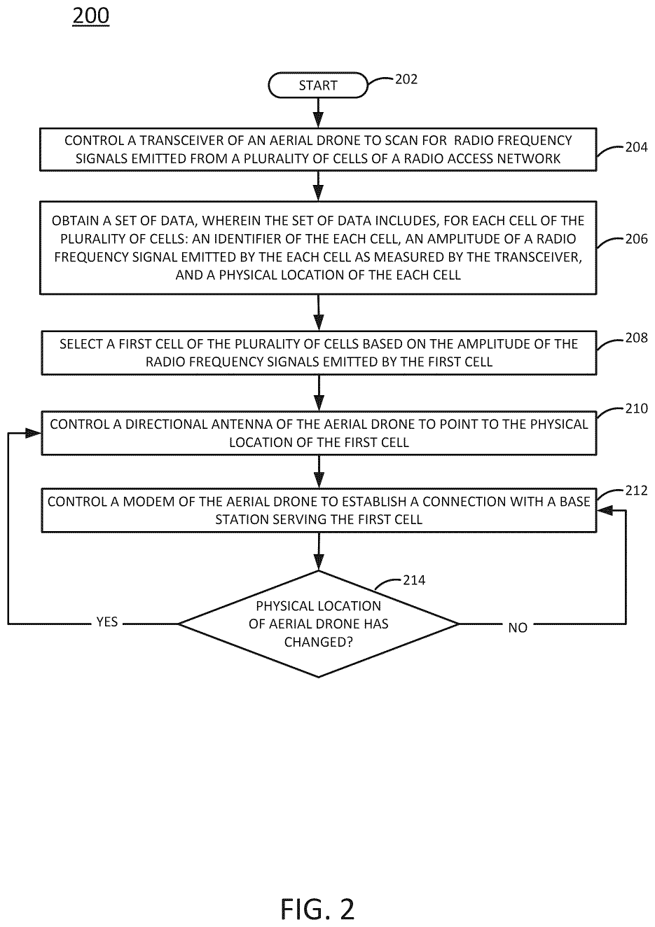

For instance, each aerial drones 116 or 118 may be equipped with circuitry to scan a surrounding radius for a base station 134, 136, 138, or 140 with a strongest signal. Each aerial drone 116 and 118 may additionally be equipped with a directional (e.g., horn style) antenna, so that once the base station with the strongest signal is identified, the directional antenna can be rotated (e.g., via a DC stepper motor) to “point” at the identified base station. A positioning system (e.g., a global positioning system) of the aerial drone 116 or 118 may track a position of the aerial drone 116 or 118 relative to the selected base station, so that the pointing of the directional antenna can be adjusted as the aerial drone 116 or 118 moves to always be pointing at the selected base station. In this way, an aerial drone 116 or 118 may “anchor” itself to a specific base station, so that the same specific base station continues to serve the aerial drone 116 or 118. For instance, an example method for automatically anchoring aerial drones to cellular base stations is discussed in further detail below in connection with FIG. 2.

In one example, one or more servers 126 and one or more databases 132 may be accessible to user endpoint devices 108, 110, 112, 114, 116, and 118 via Internet 124 in general. The server(s) 126 and DBs 132 may be associated with Internet software applications that may exchange data with the user endpoint devices 108, 110, 112, and 114 over the Internet 124. In one example, at least some of the servers 126 and DBs 132 host applications that may receive continuous uplink video transmissions from the aerial drones 116 and 118 and analyze the video transmissions to facilitate responses to emergencies.

In accordance with the present disclosure, the AS 104 may also be configured to host applications that may receive continuous uplink video transmissions from the aerial drones 116 and 118 and analyze the video transmissions to facilitate responses to emergencies. In one example, at least one of the DBs 106 or 132 may store video transmissions from the aerial drones 116 and 118 for analysis by the AS 104 and/or servers 126.

The AS 104 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for analyzing video transmissions provided by aerial drones 116 and 118.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

To further aid in understanding the present disclosure, FIG. 2 illustrates a flowchart of an example method 200 for automatically anchoring aerial drones to cellular base stations, according to the present disclosure. In one example, the method 200 may be performed by an aerial drone, such as one of the aerial drones 116 or 118 illustrated in FIG. 1 or one or more components thereof (e.g., a processor or controller of the aerial drone). However, in other examples, the method 200 may be performed by another device, such as the computing system 300 of FIG. 3, discussed in further detail below. For the sake of discussion, the method 200 is described below as being performed by a processing system (where the processing system may comprise a component of an aerial drone 116 or 118, the computing system 300, or another device).

The method 200 begins in step 202. In step 204, the processing system may control a transceiver of an aerial drone to scan for radio frequency signals emitted from a plurality of cells of a radio access network.

In one example, controlling the transceiver may include controlling a directional antenna of the aerial drone so that the transceiver can capture the radio frequency signals from all directions surrounding the aerial drone. For instance, in one example, the directional antenna may be a horn (or yagi) style antenna that is mounted on a rotating shaft that allows the antenna to be rotated in 360 degrees. A DC stepper motor (or another type of motor) may precisely control rotation of the shaft, which may be mounted to an underside of the aerial drone (although in other examples, the directional antenna and shaft could be mounted to the topside or another surface of the aerial drone).

The aerial drone may be within range of multiple different serving cells that are served by multiple different base stations of the RAN. Thus, the transceiver may detect multiple different radio frequency signals being emitted by multiple different base stations, where the amplitudes of the different radio frequency signals may vary (e.g., some signals may be stronger that others due to factors like distance, interference, network load, and the like).

In step 206, the processing system may obtain a set of data, wherein the set of data includes, for each cell of the plurality of cells: an identifier of the each cell, a signal amplitude of the radio frequency signals emitted by the each cell as measured by the transceiver, and a physical location of the each cell.

In one example, the identifier may comprise a physical cell identifier (PCI) of each cell. A PCI may uniquely identify its corresponding cell. The PCI of each cell may be obtained from an RF scanner of the aerial drone, which may detect and record the PCIs as the transceiver is scanning for the RF signals in step 204.

In one example, the amplitude of the radio frequency signals emitted by each cell may also be obtained from the RF scanner, which may measure the amplitude of the RF signals detected by the transceiver during the scanning. As discussed above, the signal amplitude observed by the transceiver may vary from cell to cell.

In one example, the physical location of each cell could be obtained from the RF scanner or from a positioning system (e.g., a global positioning system) of the aerial drone. The physical location may comprise at least the longitude and latitude of the base station that serves the cell.

In step 208, the processing system may select a first cell of the plurality of cells based on the amplitude of the radio frequency signals emitted by the first cell. In one example, the first cell may be the cell for which the amplitude of the RF signals emitted was the highest among the plurality of cells. However, in other examples the first cell may not be the cell for which the amplitude of the RF signals emitted was highest. For instance, another aerial drone may already be attached to (e.g., transmitting to) the cell for which the amplitude of the RF signals emitted was highest. In this case, the first cell could be deemed to be the cell for which the amplitude of the RF signals emitted was second highest (or even further down the rankings in terms of signal amplitude). By avoiding attaching to a cell to which another aerial drone is already attached, this may help to ensure that the resources of the cell are preserved for other (non-drone) users to the greatest possible extent.

In another example, the first cell may be a cell of the plurality of cells that is manually selected by an operator of the drone. For instance, the operator may have knowledge of which cells may currently have aerial drones operating within their serving areas, and may select the first cell as a cell that does not currently have an aerial drone operating within its serving area. In other examples, the operator may manually select the first cell based on other considerations.

In step 210, the processing system may control a directional antenna of the aerial drone to aim at the physical location of the first cell. For instance, the processing system may control the stepper motor and rotating shaft to control a direction in which the directional antenna transmits uplink signals. This direction may be a relative direction of the first cell from the current physical location of the aerial drone. The stepper motor of the rotating assembly may allow for precise aiming of the directional antenna.

In step 212, the processing system may control a modem of the aerial drone to establish a connection with a base station serving the first cell. In one example, establishing the connection with the base station may involve exchanging a series of messages with the base station to establish the connection wirelessly. Once the connection is established, the aerial drone may transmit data (e.g., video feeds captured by a camera of the aerial drone) to the base station, for delivery to a server or other devices where image/video analysis may be performed.

In step 214, the processing system may determine whether a physical location of the aerial drone has changed. In one example, a GPS system of the aerial drone may continuously track the physical location (e.g., longitude, latitude, and elevation) of the aerial drone. For instance, the aerial drone may not hover in a single physical location, but may fly (e.g., autonomously or under the control of a remote controller) around a surrounding physical environment. As the aerial drone flies, any component of the aerial drone's physical location (e.g., longitude, latitude, and/or elevation) may change at any time.

If the processing system concludes in step 214 that the physical location of the aerial drone has changed, then the method 200 may return to step 210, and the processing system may control the directional antenna to adjust so that the directional antenna continues to aim at the physical location of the first cell.

If any component of the aerial drone's physical location changes, then the position of the aerial drone relative to the first cell will also change. In one example, the processing system knows both the physical location of the first cell and the physical location of the aerial drone (from the positioning system). Thus, the processing system may continuously calculate the azimuth or bearing of the aerial drone to the first cell (e.g., to the base station serving the first cell), and may control the stepper motor and rotating shaft accordingly to ensure that the directional antenna continues to be aimed at the physical location of the first cell., even as the physical location of the aerial drone changes. This will ensure that the RF signal strength of the connection to the base station is of a relatively consistent quality, or that the aerial drone is “anchored” to the base station serving the first cell.

If, however, the processing system concludes in step 214 that the physical location of the aerial drone has not changed, then the method 200 may return to step 212, and the processing system may maintain the connection with the base station serving the first cell.

While the processing system is performing steps 204-214, the processing system may also be controlling a camera of the aerial drone to capture video of the physical location surrounding the drone. Additionally, the processing system may be controlling the transceiver to transmit the captured video to the base station serving the first cell. Thus, the aerial drone may continuously capture and stream video transmissions to the base station simultaneously with execution of the method 200. The operations of the method 200, as well as the simultaneous video transmissions, may continue until the processing system receives an instruction to stop (e.g., from an operator of the aerial drone) or the aerial drone loses the connection to the base station serving the first cell.

Thus, the method 200 effectively anchors an aerial drone to a single base station or cell of a RAN, rather than allowing the aerial drone to be handed off among multiple base stations as the aerial drone's location changes. By intelligently selecting a single base station and anchoring the aerial drone to the selected base station, more consistent RF signal strength for uplink transmissions can be achieved, which may in turn lead to better throughput for the uplink transmissions. The method 200 may also allow multiple aerial drones to be operated within a single physical location that is served by multiple cells, by allowing each aerial drone to attach to a different one of the multiple cells. This will increase the surveillance coverage of the physical location with minimal impact to users of other (non-drone) devices who are also present in the physical location.

Although not expressly specified above, one or more steps of the method 200 may include a storing, displaying, and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, any one or more of aerial drones 116 or 118 of FIG. 1 (such as might be used to perform the method 200) could be implemented as illustrated in FIG. 3. As depicted in FIG. 3, the system 300 comprises a hardware processor element 302, a memory 304, a module 305 for automatically anchoring one or more aerial drones to cellular base stations (e.g., an RF scanner), various input/output (I/O) devices 306, a transceiver 308, and a GPS receiver 310.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for automatically anchoring aerial drones to cellular base stations may include circuitry and/or logic for scanning an RF environment surrounding an aerial drone for PCIs and emitted RF signals. The input/output devices 306 may include, for example, storage devices (including but not limited to, a tape drive, a floppy drive, a hard disk drive or a compact disk drive), a receiver, a transmitter, a fiber optic communications line, an output port, or a user input device (such as a keyboard, a keypad, a mouse, and the like). In a further example, the input/output devices 306 may include a camera, such as a video camera, for capturing video of a physical location. The transceiver 308 may comprise an RF transceiver configured to communicate and exchange data (e.g., packets) with a base station of a RAN. The transceiver 308 may be coupled to directional antenna whose direction is controlled by a stepper motor and rotating shaft. The GPS receiver 310 may be configured to detect and track a physical location (e.g., latitude, longitude, and elevation) of the system 300.

Although only one processor element is shown, it should be noted that the computer may employ a plurality of processor elements. Furthermore, although only one specific-purpose computer is shown in the Figure, if the method(s) as discussed above is implemented in a distributed or parallel manner for a particular illustrative example, i.e., the steps of the above method(s) or the entire method(s) are implemented across multiple or parallel specific-purpose computers, then the specific-purpose computer of this Figure is intended to represent each of those multiple specific-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for automatically anchoring aerial drones to cellular base stations can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above-described method(s) can be perceived as a programmed processor or a specialized processor. As such, the present module 305 for automatically anchoring aerial drones to cellular base stations (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
controlling, by a processing system of an aerial drone including at least one processor, a transceiver of the aerial drone to scan for radio frequency signals emitted from a plurality of cells of a radio access network;
obtaining, by the processing system, a set of data, wherein the set of data includes, for each cell of the plurality of cells: an identifier of the each cell, an amplitude of the radio frequency signals emitted by the each cell as measured by the transceiver, and a physical location of the each cell;
selecting, by the processing system, a first cell of the plurality of cells based on the amplitude of the radio frequency signals emitted by the first cell;
controlling, by the processing system, a directional antenna of the aerial drone to aim at the physical location of the first cell; and
controlling, by the processing system, a modem of the aerial drone to establish a connection with a base station serving the first cell.

2. The method of claim 1, wherein the controlling the transceiver to scan for the radio frequency signals comprises controlling the directional antenna of the aerial drone so that the transceiver captures the radio frequency signals from all directions surrounding the aerial drone.

3. The method of claim 1, wherein the directional antenna comprises a horn style antenna mounted on a rotating shaft whose rotation is controlled by a stepper motor.

4. The method of claim 3, wherein the directional antenna and rotating shaft are mounted to an underside of the aerial drone.

5. The method of claim 1, wherein the identifier of the each cell comprises a physical cell identifier.

6. The method of claim 5, wherein the physical cell identifier is detected and recorded by a radio frequency scanner of the aerial drone while the transceiver is scanning for the radio frequency signals.

7. The method of claim 1, wherein the amplitude of the radio frequency signals emitted by the each cell is obtained from a radio frequency scanner of the aerial drone.

8. The method of claim 1, wherein the physical location of the each cell is obtained from at least one of: a radio frequency scanner of the aerial drone or a positioning system of the aerial drone.

9. The method of claim 1, wherein the physical location of the each cell comprises at least a longitude and a latitude of a base station that serves the each cell.

10. The method of claim 1, wherein the first cell is a cell for which the amplitude of the radio frequency signals emitted was highest among the plurality of cells.

11. The method of claim 1, wherein the first cell is a cell for which the amplitude of the radio frequency signals emitted was lower than a highest amplitude among the plurality of cells.

12. The method of claim 11, wherein the processing system determines that another aerial drone is already being served by a cell for which the amplitude of the radio frequency signals emitted was the highest amplitude among the plurality of cells.

13. The method of claim 1, wherein the first cell is a cell that is chosen from among the plurality of cells by an operator of the aerial drone.

14. The method of claim 1, further comprising:
determining, by the processing system, that a physical location of the aerial drone has changed since the connection to the base station serving the first cell was established; and
controlling, by the processing system, the directional antenna of the aerial drone to adjust a direction to continue aiming at the physical location of the first cell.

15. The method of claim 14, wherein the physical location of the aerial drone is defined by at least one of: a longitude of the physical location of the aerial drone, a latitude of the physical location of the aerial drone, or an elevation of the physical location of the aerial drone.

16. The method of claim 1, wherein the processing system further controls a camera of the aerial drone to capture a video of a physical location surrounding the aerial drone.

17. The method of claim 16, wherein, once the connection to the base station serving the first cell is established, the processing system further controls the transceiver to transmit the video to the base station serving the first cell.

18. A non-transitory computer-readable medium storing instructions which, when executed by a processing system including at least one processor, cause the processing system to perform operations, the operations comprising:
controlling a transceiver of an aerial drone to scan for radio frequency signals emitted from a plurality of cells of a radio access network;
obtaining a set of data, wherein the set of data includes, for each cell of the plurality of cells: an identifier of the each cell, an amplitude of the radio frequency signals emitted by the each cell as measured by the transceiver, and a physical location of the each cell;
selecting a first cell of the plurality of cells based on the amplitude of the radio frequency signals emitted by the first cell;
controlling a directional antenna of the aerial drone to aim at the physical location of the first cell; and
controlling a modem of the aerial drone to establish a connection with a base station serving the first cell.

19. The non-transitory computer-readable medium of claim 18, wherein the operations further comprise:
determining that a physical location of the aerial drone has changed since the connection to the base station serving the first cell was established; and
controlling the directional antenna of the aerial drone to adjust a direction to continue aiming at the physical location of the first cell.

20. A system comprising:
a processing system including at least one processor; and
a non-transitory computer-readable medium storing instructions which, when executed by the processing system, cause the processing system to perform operations, the operations comprising:
controlling a transceiver of an aerial drone to scan for radio frequency signals emitted from a plurality of cells of a radio access network;
obtaining a set of data, wherein the set of data includes, for each cell of the plurality of cells: an identifier of the each cell, an amplitude of the radio frequency signals emitted by the each cell as measured by the transceiver, and a physical location of the each cell;
selecting a first cell of the plurality of cells based on the amplitude of the radio frequency signals emitted by the first cell;
controlling a directional antenna of the aerial drone to aim at the physical location of the first cell; and
controlling a modem of the aerial drone to establish a connection with a base station serving the first cell.
